(19) United States
(12) Patent Application Publication
(10) Pub. No.: US 2008/0010364 A1
(43) Pub. Date: Jan. 10, 2008

(54) BLADE TYPE COMPUTER MANAGEMENT SYSTEM

(76) Inventor: Miho IWANAGA, Machida (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/774,309

(22) Filed: Jul. 6, 2007

(30) Foreign Application Priority Data
Jul. 6, 2006 (JP) 2006-186554

(51) Int. Cl. G06F 15/177

(52) U.S. Cl. 709/220

(57) ABSTRACT

A blade type computer management system comprising one or more server racks, each rack having one or more chassis mounted thereon, each chassis having one or more blade type computers mounted thereon which are connected to a network. A management computer is connected to the network for managing the respective blade type computers. The management computer manages information on the positions of the respective blade type computers notified by these blade computers, based on the position information.

### INCORPORATION BY REFERENCE

The present application claims priority from Japanese application JP2006-186554 filed on Jul. 6, 2006, the content of which is hereby incorporated by reference into this application.

### BACKGROUND OF THE INVENTION

1. Field of the Invention

The present invention relates to blade type computer management systems and more particularly to a technique effective to confirm a position where the blade type computer is mounted.

2. Description of the Related Art

A blade type computer is connected over a network to a user terminal where the user performs console inputting operations, using a mouse or a keyboard, such that the computer processes as inputs thereto the console inputs from the user terminal to send corresponding image information to the user terminal. This allows the user to operate the blade type computer. Since each user occupies one blade type computer, such computers are required to be the same in number as the users who use those respective computers simultaneously.

Blade servers are similar in technique to the blade type computers. A single blade server is shared by a plurality of servers. Thus, the blade servers are smaller in number than the users who use these respective servers simultaneously. In this respect, the blade servers are different from the blade type computers.

A control system in which a management server that manages the positions of the blade servers in a server rack is disclosed, for example, in JPA-2005-339528.

### SUMMARY OF THE INVENTION

When the blade type computers are installed, they must be the same in number as the users who use those respective computers simultaneously. Thus, when there are many users, a like number of blade type computers are required to be installed and managed in a centralized manner. In addition, installation of many such computers requires a plurality of server racks, which would increase the man-hour of maintenance/management by a maintenance manager.

With the blade servers disclosed in the JPA-2005-339528, they are smaller in number than the users who use the respective blade servers simultaneously and those blade severs are received in a single server rack. Thus, the mounting positions of blade servers are managed only in this single server rack. Therefore, the mounting positions of blade servers in a plurality of server racks cannot be managed.

It is therefore an object of the present invention to provide a blade type computer management system capable of managing the mounting positions of blade type computers in a plurality of server racks, and reducing the man-hour of maintenance/management of the mounting positions of the blade type computers by a maintenance manager.

A typical one of the inventions disclosed in this application is summarized as follows:

A blade type computer management system according to the present invention comprises one or more server racks, each rack including one or more chassis, each chassis including one or more blade type computers which are connected to a network; and a management computer connected to the network for managing the respective blade type computers. The management computer manages information on the position of a respective one of the one or more blade type computers, notified by the blade computer, based on that position information.

### BRIEF DESCRIPTION OF THE DRAWINGS

FIG. 1 illustrates a blade type computer management system according to one embodiment of the present invention;

FIG. 2 illustrates one example of information on the mounting positions of chassis in the system of FIG. 1;

FIG. 3 illustrates one example of information on the mounting positions of blades in the system of FIG. 1; and

FIG. 4 illustrates operation of the system of FIG. 1.

### DETAILED DESCRIPTION OF THE INVENTION

An embodiment of the present invention will be illustrated in detail with reference to the accompanying drawings. As a rule, like parts are denoted by like reference numerals throughout all the drawing figures and further description thereof will be omitted.

<Configuration of a Blade Type Computer Management System>

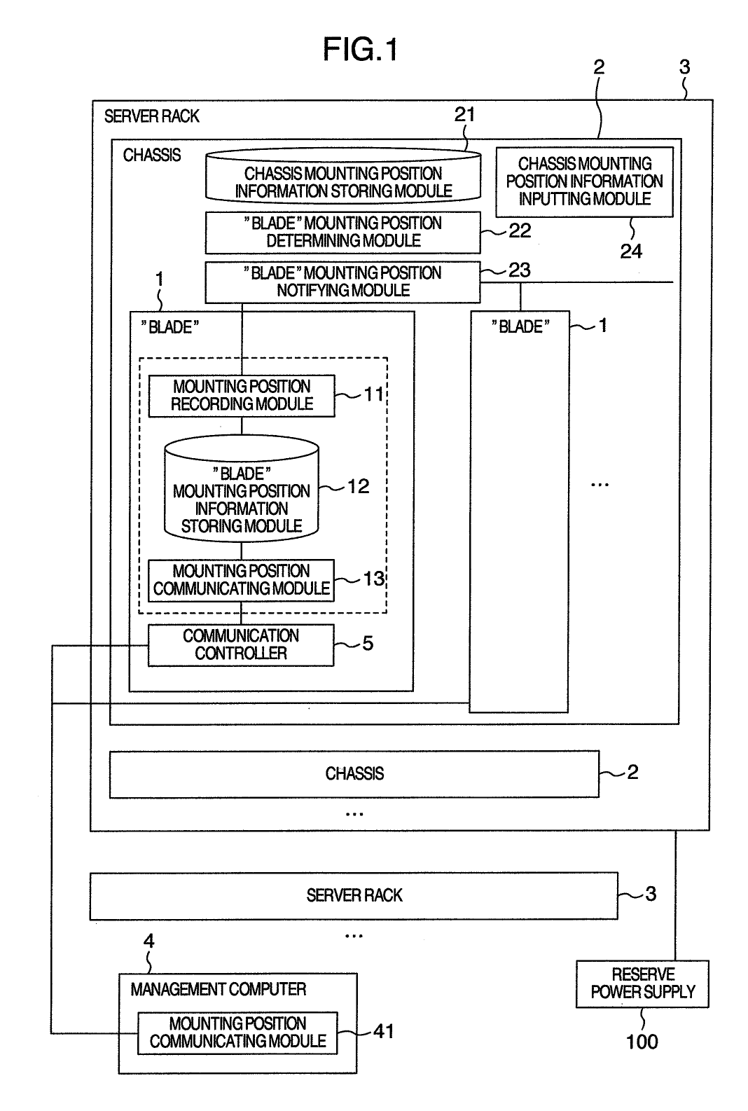

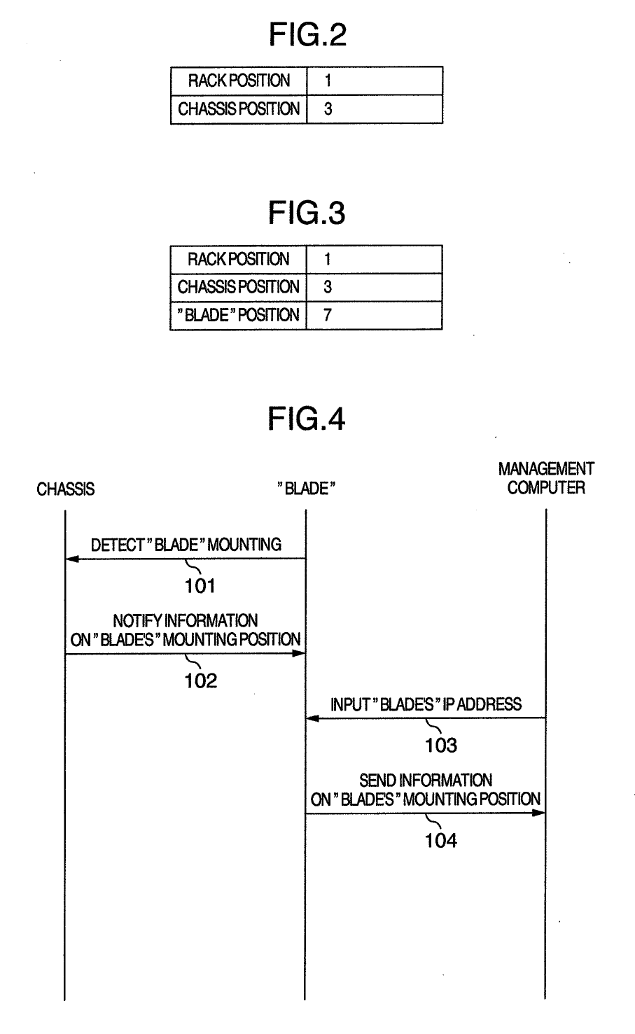

Referring to FIGS. 1-3, the configuration of a blade type computer management system according to one embodiment of the present invention will be described. FIG. 1 illustrates a blade type computer management system according to one embodiment of the present invention. FIG. 2 illustrates one example of information on the mounting positions of chassis in the system of FIG. 1. FIG. 3 illustrates one example of information on the mounting positions of blades in the system of FIG. 1.

In FIG. 1, the blade type computer management system includes one or more server racks 3 on each of which one or more chassis 2 are mounted. Each chassis 2 has one or more slots in one or more of which a like number of blade type computers (each of which is hereinafter referred to as a “blade”) 1 are mounted. The system further includes a management computer 4 which is connected over a network with each of the blades 1.

Each blade is an independently operable computer which includes the basic functions of a computer such as a CPU, memories, storing modules, external input/output devices, etc.

Each blade 1 includes a blade mounting position recording module 11 that receives from a chassis 2 where the blade was mounted information on its position on the chassis 2 when the blade was mounted and records the information, a storing module 12 that stores the position information recorded by the recording module 11, and a blade mounting position communicating module 13 that communicates with the management computer 4 over the communication controller 5 concerning required matters including responding to an inquiry about the mounting position of the blade from the management computer 4.

The communication controller 5 is operated in a switched manner such that it communicates normally with the management computer 4, for example, in accordance with an operating system (OS) stored in storage of the blade 1 and, when the blade 1 is in maintenance or malfunction, with the blade mounting position communicating module 13.

The blade mounting position communicating module 13 may directly communicate with the management computer 4 instead of over the communication controller 5.

The communication controller 5 and the blade mounting position communicating module 13 are arranged to be supplied with power from a reserve power supply 100 to communicate with the management computer 4 when not supplied with power from a usual power supply, for example, due to malfunction of the blade 1.

The blade mounting position recording module 11, blade mounting position information storing module 12 and blade mounting position communicating module 13 of a blade 1 provided in a chassis 2 may compose a control chip which communicates over an associated communication controller 5 of that blade with another chassis 2.

Each chassis 2 includes a chassis mounting position information inputting module 24 at which information on the mounting position of a chassis 2 is input in the initial setting, a chassis mounting position information storing module 21 that sores information on the mounting position of the chassis 2 input by the inputting module 24, a blade mounting position determining module 22 that, when the blade was mounted in a slot in the chassis, determines the position of the slot, and a blade mounting position notifying module 23 that notifies the mounted blade 1 of its mounting position.

The information which the notifying module 23 notifies includes information on the chassis mounting position stored in the chassis mounting position information storing module 21 and information on the position of the slot in the chassis in which the blade 1 is mounted and which the blade mounting position determining module 22 has determined.

The management computer 4 includes a blade mounting position communicating module 41 that requests and receives from a blade 1 connected over the network the information on the mounting position of the blade 1.

As shown in FIG. 2, the information on the chassis mounting position stored in the chassis mounting position storing module 21 of the chassis 2 includes information on the chassis and rack positions received from the chassis mounting position information inputting module 24 when the chassis 2 is provided.

As shown in FIG. 3, the information on the blade mounting position stored in the blade mounting position information storing module 12 includes information on the chassis, rack and blade positions. When a blade 1 is mounted on the chassis 2, the information on the blade mounting position determined by the blade mounting position determining module 22 is notified by the blade mounting position notifying module 23 to the blade mounting position recording module 11 of the blade 1. Then, the recording module 11 records the information in the blade mounting position information storing module 12.

<Operation of the Blade Type Computer Management System>

Referring to FIG. 4, operation of the blade type computer management system according to the embodiment of the present invention will be described. FIG. 4 illustrates the operation of the system, and especially an operation flow among a blade 1, a chassis 2 and the management computer 4 of the system.

When the chassis 2 is set, the chassis mounting position information inputting module 24 inputs information on the chassis mounting position to the chassis mounting position storing module 21.

When the blade 1 is mounted on the chassis, the blade mounting position determining module 22 detects this fact and determines the blade mounting position in the chassis 2 (step 101).

The blade mounting position notifying module 23 notifies to the blade 1 the information on the blade and chassis mounting positions stored in the storing module 21 (step 102).

The blade 1 records the information on the blade mounting position in the blade mounting position information storing module 12 with the blade mounting position information recording module 11 for storing purposes.

A personnel manager who uses the management computer 4 inputs an IP address of a blade 1 whose mounting position should be checked to cause the mounting position communicating module 41 to request from the blade 1 information on its mounting position (step 103). In response, the mounting position communicating module 13 of the blade 1 sends the information stored in the blade mounting position information storing module 12 to the management computer 4 via the communication controller 5 (step 104).

Thus, the manager can know the blade mounting position.

The information which the manager inputs is only required to be the one by which the blade 1 can be specified uniquely in the network, for example, IP address, a MAC address or a computer name. Alternatively, the management computer 4 may periodically request from all the blades 1 to be managed the latest information on their mounting positions, and then receive and store the information therein.

As described above, according to the present embodiment, when a chassis 2 is set in a server rack 3, the chassis mounting position information inputting module 24 sets information on the chassis mounting position in the storing module 21. When a blade 1 is mounted on the chassis 2, the blade mounting position notifying module 23 notifies to the blade 1 the information on the blade mounting position determined on the chassis 2 side and the information on the chassis mounting position stored in the storing module 21. Thus, the blade 1 can grasp its own mounting position. The management computer 4 can request and know the blade mounting position from the blade 1, thereby facilitating maintenance/management.

The communication controller 5 and the mounting position communicating module 13 of the blade 1 are arranged to be supplied with power from a reserve power supply in a malfunction condition, thereby allowing the management computer 4 to be notified of the information on the blade mounting position.

Since the management computer 4 communicates with a respective one of the plurality of blades 1 via the network that the blades 1 use in general communications without communicating with the server rack 3 and chassis 2, the management computer 4 can know the blade mounting position without the need to provide any special communicating modules on the server rack 3 and chassis 2 concerned.

While the specified embodiment of the present invention has been described and illustrated, it will be apparent to those skilled in the art that numerous modifications and variations can be made without departing from the scope of the invention as defined in the appended claims.

The present invention relates to the blade type computer management systems and is also applicable to systems which confirm the mounting positions of blade type computers and performs their maintenance/management.

Advantages that are produced by typical ones of the inventions disclosed in the present application will be outlined as follows:

The mounting position of each of one or more blade type computers in a respective one of a plurality of server racks is manageable according to the present invention. Thus, the present invention has the advantage of taking no time to manage the mounting position of each blade type computer. Furthermore, the present invention has the advantage of reducing the maintenance time because it takes no time to locate the mounting position of a blade type computer when troubles occur to this computer.

It should be further understood by those skilled in the art that although the foregoing description has been made on embodiments of the invention, the invention is not limited thereto and various changes and modifications may be made without departing from the spirit of the invention and the scope of the appended claims.

1. A blade type computer management system comprising:
one or more server racks, each rack having one or more chassis provided thereon, each chassis having one or more blade type computers mounted thereon, each computer being connected to a network; and
a management computer connected to the network for managing the respective blade type computers, and wherein:
the management computer manages information on the position of a respective one of the one or more blade type computers, notified by that blade computer, based on the position information.

2. The system of claim 1, wherein each blade type computer comprises:
means for recording information on the mounting position of the blade type computer;
means for storing the information on the mounting position of the blade type computer recorded by the recording means; and
means for communicating with the management computer to send the information on the mounting position of the blade type computer to the management computer.

3. The system of claim 2, wherein:
the storing means and the communicating means are supplied with power from a reserve power supply when the blade type computer is in malfunction such that the communicating means may communicate with the management computer.

4. The system of claim 2, further comprising:
a communication controller provided in the blade type computer for control of communication with an external entity, and wherein:
the communicating means communicates with the management computer via the communication controller.

5. The system of claim 4, wherein the communication controller:
makes normal communication with the external entity based on an operating system provided in the blade type computer when the same operates in a normal manner, and
communicates with the communicating means when the blade type computer is in malfunction or when the communication controllerreceives an inquiry from the management computer.

6. The system of claim 5, wherein:
when the blade type computer is in malfunction, the storing means, the communicating means and the communication controller are supplied with power from a reserve power supply such that the communicating means and the communication controller communicate with the management computer.

7. The system of claim 2, wherein:
the recording means, the storing means and the communicating means compose a control chip.

8. The system of claim 1, wherein each chassis has mounted thereon:
means for storing information on the mounting position of the chassis;
means for determining the mounting position of the blade type computer in the chassis; and
means for, when the blade type computer is set in the chassis, notifying the blade type computer of its mounting position.

9. The system of claim 8, wherein the chassis further has mounted thereon:
means for, when the chassis is set in the server rack, inputting the information on the mounting position of the chassis to the storing means.

10. The system of claim 1, wherein the management computer comprises:
means for communicating with each blade type computer via the network and for receiving information on the mounting position of the blade type computer from the same.
